(19) United States
(12) Patent Application Publication
(10) Pub. No.: US 2004/0118995 A1
(43) Pub. Date: Jun. 24, 2004

(54) Correction for non-linearities in FTIR photo detectors

(76) Inventor: Raul Curbelo, Lexington, MA (US)

Correspondence Address: SCULLY SCOTT MURPHY & PRESSER, PC, 400 GARDEN CITY PLAZA, GARDEN CITY, NY, 11530

(21) Appl. No.: 10/626,800

(22) Filed: Jul. 24, 2003

Related U.S. Application Data
(60) Provisional application No. 60/398,478, filed on Jul. 25, 2002.

(51) Int. Cl. G01J 3/50; H01J 5/16; H01J 40/14

(52) U.S. Cl. 250/226

(57) ABSTRACT

A method and for acquiring interferogram data and a Fourier transform spectrometer, including a detector that provides an output signal that exhibits non-linear distortion in a measured interferogram represented by a power series Iₘ=a₁I+a₂I²+a₃I³+ . . . , comprising the steps of representing a measured spectrum as Sₘ=a₁ S+a₂(S*S)+a₃ (S*S*S)+b₃ (S*S*S*S)+ . . . where S is the spectrum of the linear interferogram and * indicates convolution, expressing a linear interferogram I as a power series of a measured interferogram Iₘ as in I=b₁Iₘ+b₂Iₘ²+b₃Iₘ³+ . . . , expressing the linear spectrum as a power series of the spectra of the interferogram powers S=b₁S₁+b₂S₂+b₃S₃ . . . , and obtaining the coefficients bᵢ where S=0.

### CROSS REFERENCE TO RELATED APPLICATIONS

The present application claims benefit of U.S. Provisional Application No. 60/398,478 filed Jul. 25, 2002.

### FIELD OF THE INVENTION

The present invention relates generally to photodetectors and more specifically to techniques for correcting detector non-linearity with available spectral data.

### BACKGROUND OF THE INVENTION

The general principles of Fourier transform spectroscopy are well known. In the typical spectrometer, two coherent beams of electromagnetic radiation are combined after traversing different optical paths producing an interference pattern. The intensity in the interfering pattern varies depending on the spectrum of the interfering beams. By recording the intensity as a function of the path difference between the two interfering beams, the power spectrum can be deduced.

A Fourier transform spectrometer typically includes an interferometer into which an infrared beam to be analyzed and a monochromatic reference beam (typically in the visible range) are directed. The interferometer, typically a Michelson interferometer, has a fixed mirror and a movable mirror which is driven at a nominally constant velocity over a portion of its travel. Each of the input beams is split at a beam splitter with a first portion traveling a path that causes the first portion to reflect from the fixed mirror and a second portion traveling a path that causes the second portion to reflect from the movable mirror. The portions of each beam recombine at the beam splitter, and the recombined infrared and monochromatic beams are directed to appropriate photodetectors (detectors). The Fourier transform spectrometer includes a sample compartment, the detector on which an interferogram is formed and signal processing electronics for processing an electronic signal representative of the interferogram and for Fourier transforming said signal. Typical detectors are a high sensitivity thermal deuterated-triglycine-sulfate (DTGS) detector or a liquid nitrogen cooled mercury-cadmium-telluride (MCT) detector.

Due to optical interference between the two portions of each beam, the intensity of the monochromatic beam is modulated at a frequency proportional to its optical frequency and the mirror velocity while each frequency component of the infrared beam is modulated at a frequency proportional to that component's optical frequency and the mirror velocity.

Typically, each detector has associated circuitry to generate a voltage representative of (preferably proportional to) the light intensity falling on the detector. The infrared detector output signal therefore represents the superposition of the modulated frequency components and provides an interferogram whose Fourier transform yields the desired spectrum. The monochromatic detector provides a nominally sinusoidal reference signal whose zero crossings occur each time the moving mirror travels an additional one quarter of the reference wavelength. The data acquisition electronics are triggered on these zero crossings to provide regularly sampled values for the interferogram. With the appropriate choice of mirror velocity, the output signal can be made to fall within a convenient range of modulation frequencies, as for example, in the audio range. Certain types of detectors, such as photodiodes and photomultiplier tubes are typically used with DC amplifiers, while others, such as photoconductors, are typically used with AC amplifiers. In either case, the average value of the interferogram provides no useful spectral information, and is typically subtracted out before performing the Fourier transform.

The resulting Fourier transform is known to be inaccurate because of non-linearities in the detector and in the associated signal processing circuitry. The conventional MCT detector preamplifiers maintain a fixed current through the MCT detector and measure the voltage generated across the MCT detector. In effect, therefore, the resistance change caused by the illumination or incident light typically is monitored, rather than the change of conductance through the MCT detector. This technique generally has resulted in inherently non-linear output measurements. While compensation techniques exist for reducing these inaccuracies (see, for example, U.S. Pat. No. 4,682,022), these techniques are not altogether satisfactory since residual errors still remain and they require significant signal processing resources.

The photoconductive material of a detector has a conductivity that varies with the luminous flux falling on the material. Ideally a photoconductor would have a linear characteristic, so that when it is biased with a constant voltage, the current through it would vary linearly with the intensity. It is well known to use negative feedback in the preamplifier to provide an output voltage that is a direct measure of the detector current.

Photoconductors however are not linear, but rather exhibit non-linear behavior that to some extent approximates that of an ideal photoconductor in series with a fixed resistance. In the context of a Fourier transform spectrometer, the non-linearity in the detector output signal manifests itself by distorting the resultant spectrum in the wavelength regions where the detector is sensitive, and producing artifacts indicating the presence of energy in wavelength regions where the detector is actually insensitive. A typical approach is to accept the non-linearity as inevitable, and operate in a range of low infrared source intensity where the detector characteristic is approximately linear. This is sometimes undesirable, however, since a greater source intensity would improve the signal-to-noise ratio of the spectral measurement.

It is also known to correct the non-linearity by providing positive feedback in the preamplifier circuit so as to balance out the non-linear effect of the internal series resistance. While the positive feedback approach is somewhat effective in correcting the detector non-linearity, the use of positive feedback will increase the effective noise of the amplifier. This is not a problem for relatively noisy detectors where the detector noise (as opposed to the amplifier noise) is the limiting factor in the overall signal-to-noise ratio. However, current state of the art detectors are characterized by low noise; therefore, amplifier noise becomes a performance-limiting factor. For example, if the detector noise is only on the order of twice the preamplifier noise, the effect of positive feedback in the preamplifier will be to raise the preamplifier noise to the same level as the detector noise.

These detectors have a cutoff frequency such that they do not respond to incident radiation having a frequency less than the cutoff frequency. The region of the spectrum below the detector cutoff, where the spectrum of the linear interferogram is zero, can provide information on the non-linear transformation of the interferogram due to the non-linearity of the detector.

### SUMMARY OF THE INVENTION

The invention comprises a method of acquiring interferogram data in a Fourier transform spectrometer. The spectrometer includes a detector that provides an output signal that exhibits non-linear distortion in a measured interferogram represented by a power series Iₘ=a₁I+a₂I²+a₃I³+ . . . . The method comprises the steps of representing a measured spectrum as Sₘ=a₁S+a₂(S*S)+a₃ (S*S*S)+b₃ (S*S*S*S)+ . . . where S is the spectrum of the linear interferogram and * indicates convolution; expressing a linear interferogram I as a power series of a measured interferogram Iₘ as I=b₁Iₘ+b₂Iₘ²+b₃Iₘ³+ . . . ; expressing the linear spectrum as a power series of the spectra of the interferogram powers S=b₁S₁+b₂S₂+b₃S₃ . . . ; measuring the non-linear effects of the detector from one or more resolution elements in spectral regions known to have no energy; and obtaining the coefficients bᵢ where S=0 by applying the measured non-linear effects to S=b₁S₁+b₂S₂+b₃S₃+ . . . .

### BRIEF DESCRIPTION OF THE DRAWINGS

FIG. 1 is a schematic diagram depicting an illustrative embodiment of a Fourier transform infrared spectrometer with which the invention may be practiced;

FIGS. 2-7 are illustrative spectra useful in understanding the invention.

### DETAILED DESCRIPTION

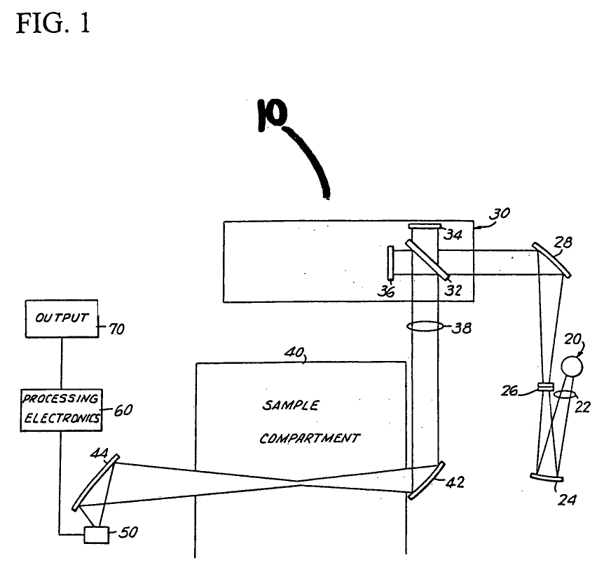

As shown in FIG. 1, a basic Fourier transform infrared spectrometer 10 typically comprises an infrared radiation source 20, an interferometer 30, a sample compartment or sample stage 40, an infrared detector 50, an electronic signal processor 60 and an output interferogram 70. An infrared radiation beam 22 is directed by a mirror 24 through one of a plurality of apertures 26 and is reflected by a second mirror 28 into the interferometer 30. The interferometer 30 typically comprises a beam splitter 32, a first fixed mirror 34, and a second movable mirror 36 that is scanned by a suitable actuator (not shown). The beams are recombined by the beam splitter 32 and exit 38 incident on mirror 42. Mirror 42 directs the recombined beam through the sampling compartment 40 onto a second mirror 44 that reflects the beam onto the detector 50 where the interferogram is formed.

The detector 50 and electronic signal processor and associated electronics 60 convert the interferogram into an electrical signal that is processed by a computer to generate an appropriate output such as the interferogram, which is a plot of the spectrum of the sample. Typical detectors are high sensitivity thermal deuterated-triglycine-sulfate (DTGS) detectors or liquid nitrogen cooled mercury-cadmium-telluride (MCT) detectors. The detector has a cutoff frequency below which there is no response to incident radiation. The electronics 60 amplify an analog signal from the detector 50, convert it to a digital signal and Fourier transform the digital signal to produce the sample spectrum. The output 70 may be on any one or more appropriate devices for displaying and/or recording the output signal from the spectrometer.

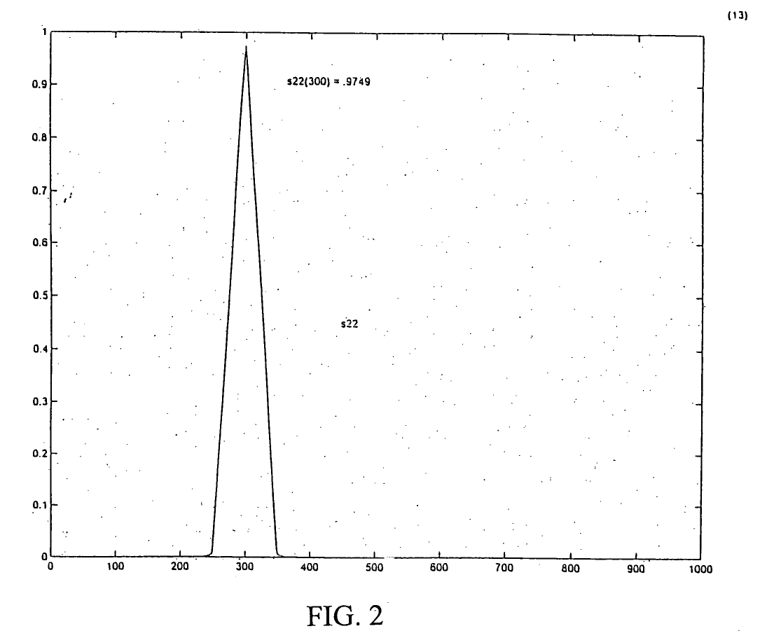

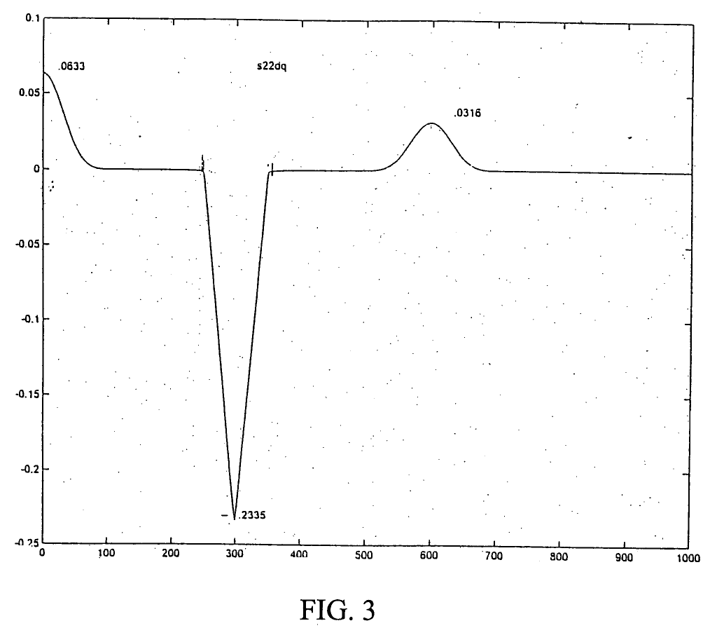

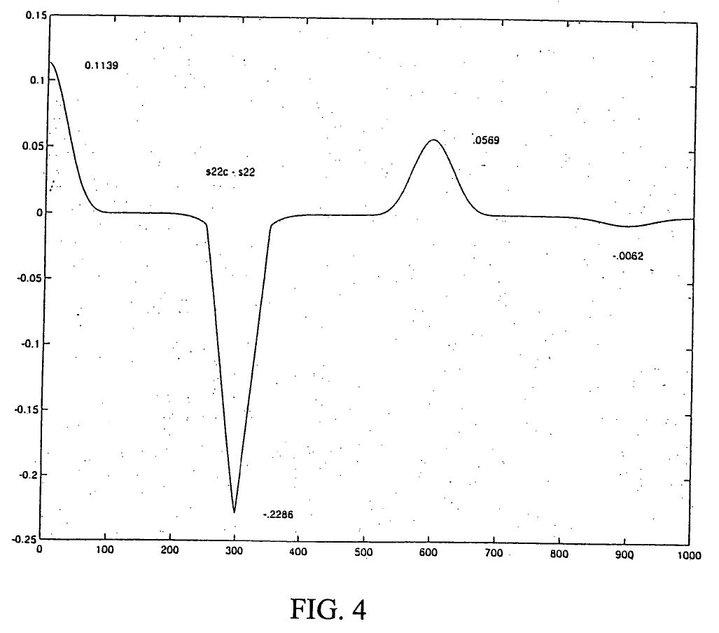

The spectrum of the interferogram of a narrow band spectrum shown in FIG. 2 is used to show the spectral components of the second and third order convolutions in FIGS. 3 and 4. FIGS. 3 and 4 also show that the contribution of the non-linearity at zero frequency includes the effect of all the convolutions, not only that of the second order, with not enough information of separating the contributions of the different convolutions in the case of broadband spectrum.

The interferogram produced by the electronic signal processor and electronics 60 contains spectral components above the cutoff frequency of the detector 50; and because of non-linearities in the detector 50 and in the electronic signal processing circuitry 60, it also has spectral components below the cutoff frequency. When a Fourier transform is made of this interferogram, it has a signal spectrum above the cutoff frequency of the detector and also a spectrum below the cutoff frequency of the detector.

The present invention uses a method that corrects the Fourier Transform Infrared Spectrometer (FTIR) detector non-linearity in the interferogram with spectral data that can be wider than one octave using the spectral information in the measured spectrum. The correction assumes that the non-linearity distortion in the measured interferogram can be represented by a power series of the unknown linear interferogam.

Iₘ=a₁I+a₂I²+a₃I³+a₄I⁴+ . . . (1)

The measured spectrum is the Fourier transform of (1) and can be written as

Sₘ=a₁S+a₂(S*S)+a₃ (S*S*S)+b₃ (S*S*S*S)+ . . . (2)

where S is the spectrum of the linear interferogram and the (*) indicates convolution.

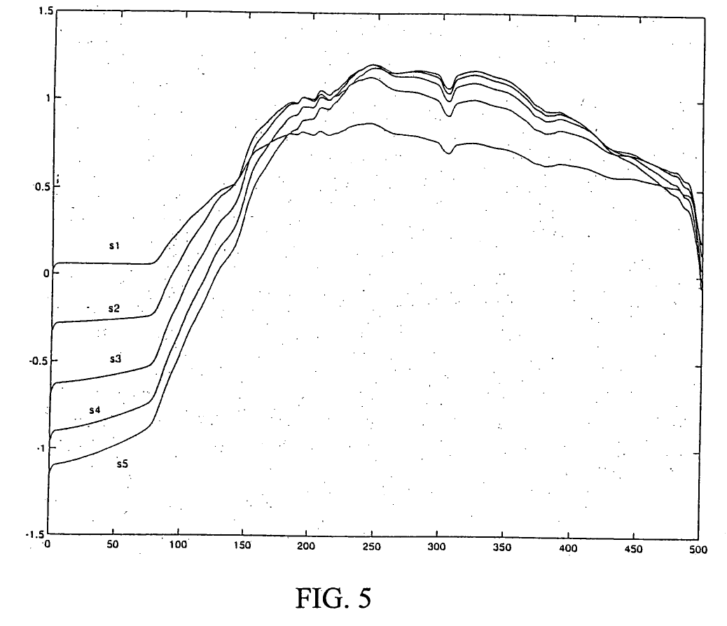

For the case of a spectrum bandwidth comparable or larger than one octave, these spectral contributions overlap as shown in FIG. 5 where S is the spectrum of Iⁱ. The abscissa in the spectra is arbitrary and was chosen for simplicity of the numerical calculations.

If one expresses the linear interferogram I as a power series of the measured interferogram Iₘ

I=b₁Iₘ+b₂Iₘ²+b₃Iₘ³+b₄Iₘ⁴+ . . . (3)

The linear spectrum can be expressed as a power series of the spectra of the interferogram powers

S=b₁S₁+b₂S₂+b₃S₃+b₄S₄+ . . . (4)

To obtain the linear spectrum we need to determine the coefficients bᵢ.

One finds that more information is available than the measured spectral value at zero frequency. All the spectral regions that are known to have no energy, that is no signal with a linear detector, can provide information on the non-linear characteristics of the actual detector.

As these regions of the spectrum have as many different measurements as resolution elements are in these regions, it is possible to obtain many independent measurements of the non-linear effect from the spectrum of the measured interferogram. Applying those measurements to equation (4), and knowing that S=0 in these regions, a set of linear equations can be written from which one can obtain the bᵢ.

One set of embodiments of the present invention is to select a set of m measurements of the spectra of the powers of the measured interferogram from 1 to n+1, in the regions that it is known the linear spectrum is zero.

Making b₁=1, and neglecting the power higher than n+1, from equation 4, one can write a set of linear equations for j=1 to m.

b₂S_{,j,2}+b₃S_{j,3}+ . . . +bₙ₊₁S_{j, n+1}=−S_{j, 1} for j=1 to m (5)

where S_{j,i} is the jₜₕ measurement of the spectrum of the iₜₕ power of the measured interferogram.

For m=n this equation can be solved to get the values bᵢ that satisfy equation (4). Using equation (4), one can compute an estimate of the spectrum of the linear interferogram.

If one uses two values in the spectra S₁, S₂ and S₃, in the region below 60, one can write two equations with two unknowns. The unknowns are the coefficients of the second and third order term in equation (3), b₂ and b₃. These coefficients will correct for the quadratic and cubic components of the non-linearity.

b₂S_{1,2}+b₃S_{1,3}=−S_{1,1}

b₂S_{2,2}+b₃S_{2,3}=−S_{2,1}

To solve this set of equations one must invert the matrix A, that involves dividing by the determinant of A, A=[S_{1,2} S_{1,3} S_{2,2} S_{2,3}].

In this case, the value of the determinant of A is very small with respect to the components of A, and the result being the small differences between large numbers, therefore magnifying any errors from the measurement and the underlying assumptions. The poor result can be understood because these regions of the spectrum include contributions from the spectra of all the power of the measured interferogram.

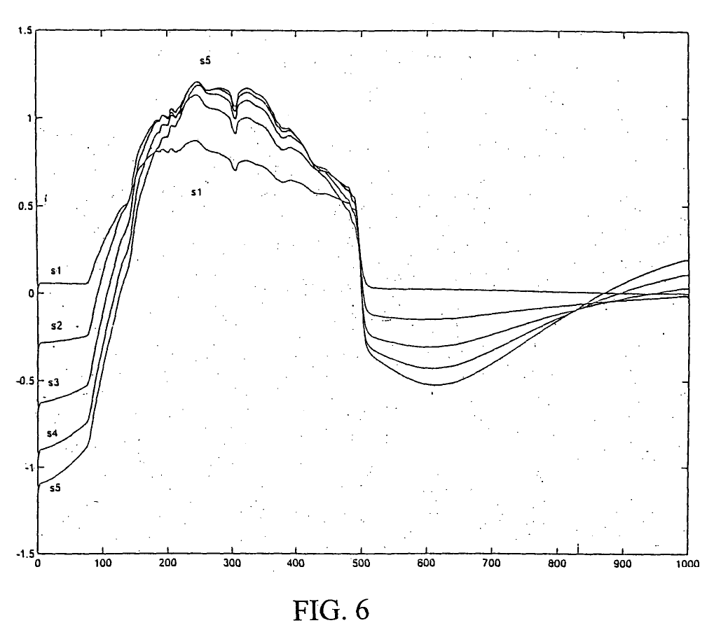

FIG. 6 includes the low frequency region below the detector cutoff and another area above the highest frequency where the spectrum is not zero. In this case, the linear spectrum is known to be zero for all frequencies below 80 and above 500. The important fact is that the spectra of the increasing powers of the measured interferogram are quite different above 500. The spectrum S₂ is zero at 1000, because the linear spectrum S is zero above 500. The larger the bandwidth of the spectrum of the measured interferogram, the more independent are the contributions from the spectra of successive powers of the measured interferogram.

Taking the values of S₁, S₂ and S₃, at one point below 70 and another near 1000, the determinant of A is more than one order of magnitude larger than the case above, the results are much better.

Another embodiment is to use m>n, which gives an overdetermined set of equations. In this case, using the Least Square Approximation, which will give the bᵢ with minimum square error, is the best solution to the set of equations. The well known Least Square Approximation (Isa) method provides a mean fit between a series of data points. Lsa helps determine trend lines for a series of data points. This embodiment is desirable when the square matrix is ill conditioned, again when the determinant value is very small, and using more of the spectral information available in the measured interferogram is desired.

A preferred embodiment uses for each of the measurements S_{j,i} the average of several resolution elements in the spectra of the powers of the measured interferogram, which will reduce the effects of the noise in the spectra to the computation of the bᵢ.

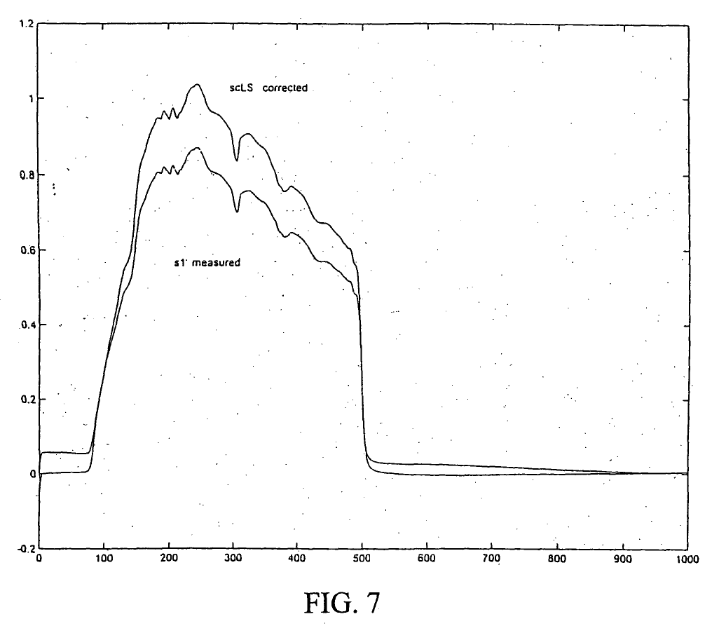

FIG. 7 shows the measured spectrum and a corrected spectrum using first, second and third order correction, with five spectral measurements of the spectra of the powers of the measured interferogram.

The measured interferogram I in equation (1) is an absolute measurement, to be referenced to the zero light value. Therefore the interferogram is measured with a DC coupled signal channel. In some cases, it may be desirable to collect the interferogram with an AC signal channel to optimize the dynamic range available from the analog to digital converter (A/D). In this case a separate measurement of the same interferogram can be made with a DC coupled signal channel to obtain the DC offset needed to reference the measured interferogram to the zero light value. As all detectors can be assumed to be linear for small signals, aᵢ and bᵢ above can be made unity with no loss of generality.

This procedure is not only applicable to single point detectors, but it can be used with arrays of detectors of one or two dimensions such as a linear CCD or a two dimensional CCD array. The procedure is also applicable to a wide variety of photo detectors used in FTIR, including photovoltaic, photoconducting and bolometer type detectors.

Accordingly, it should be readily appreciated that the device and method of the present invention has many practical applications. Additionally, although the preferred embodiments have been illustrated and described, it will be obvious to those skilled in the art that various modifications can be made without departing from the spirit and scope of this invention. Such modifications are to be considered as included in the following claims.

What is claimed is:

1. A method of acquiring interferogram data in a Fourier transform spectrometer, the spectrometer including a detector that provides an output signal that exhibits non-linear distortion in a measured interferogram represented by a power series Iₘ=a₁I+a₂I²+a₃I³+ . . . , comprising the steps of:
representing a measured spectrum as Sₘ=a₁S+a₂(S*S)+a₃(S*S*S)+b₃(S*S*S*S)+ . . . where S is the spectrum of the linear interferogram and * indicates convolution;
expressing a linear interferogram I as a power series of a measured interferogram Iₘ as I=b₁Iₘ+b₂Iₘ²+b₃Iₘ³+ . . . ;
expressing the linear spectrum as a power series of the spectra of the interferogram powers S=b₁S₁+b₂S₂+b₃S₃ . . . ;
measuring the non-linear effects of the detector from one or more resolution elements in spectral regions known to have no energy; and
obtaining the coefficients bᵢ where S=0 by applying the measured non-linear effects to S=b₁S₁+b₂S₂+b₃S₃+ . . . .

2. The method of claim 1 wherein:
a set of m measurements from 1 to n+1 is selected from the spectra of the powers of the measured interferogram where S=0; and
making b₁=1 and m=n.

3. The method of claim 1 wherein:
a set of m measurements from 1 to n+1 is selected from the spectra of the powers of the measured interferogram where S=0;
m>n;
and the least square approximation is used to find bᵢ.

4. The method of claim 1 wherein:
for each measurement of the measured spectra the average of 2 or more resolution elements in the spectra of the powers of the measured interferogram is used to compute bᵢ.

5. The method of claim 1 wherein:
the measured interferogram is collected by an AC signal channel and a DC offset is taken from the measured interferogram collected by a DC coupled signal channel.

6. The method of claim 1 wherein:
the detector is a single point detector.

7. The method of claim 1 wherein:
the detector is a one dimensional detector.

8. The method of claim 1 wherein:
the detector is a two dimensional detector.

9. The method of claim 1 wherein:
the detector is a photovoltaic detector.

10. The method of claim 1 wherein:
the detector is a photoconducting detector.

11. The method as in claim 1 wherein:
the detector is a bolometric detector.

12. A Fourier transform spectrometer comprising:
an interferometer;
a reference electromagnetic radiation source;
an infrared radiation source;
a detector that provides an output signal from the reference and infrared sources that exhibits a non-linear variation;
a preamplifier circuit, responsive to the output signal, producing an output signal;
an amplifier circuit, responsive to the preamplified signal, producing an output signal;
means for digitizing the amplified output signal to provide a measured interferogram;
signal processing means for acquiring interferogram data wherein the measured interferogram is represented as a measured spectrum Sₘ=a₁S+a₂(S*S)+a₃(S*S*S)+b₃(S*S*S*S)+ . . . wherein S is the spectrum of the linear interferogram and * indicates convolution, a linear interferogram I is expressed as a power series of a measured interferogram Iₘ as in I=b₁Iₘ+b₂Iₘ²+b₃Iₘ³+ . . . , the linear spectrum is expressed as a power series of the spectra of the interferogram powers S=b₁S₁+b₂S₂+b₃S₃ . . . , and the coefficients bᵢ are computed where S=0.

13. A Fourier transform spectrometer as in claim 12 wherein:
the signal processing means selects a set of m measurements from 1 to n+1 from the spectra of the powers of the measured interferogram where S=0; and
maks b₁=1 and m=n.

14. A Fourier transform spectrometer as in claim 12 wherein:
the signal processing means selects a set of m measurements from the spectra of the powers of the measured interferogram from 1 to n+1 where S=0; and
makes m>n; and
uses the least square approximation to find bᵢ.

15. A Fourier transform spectrometer as in claim 12 wherein:
the signal processing means uses for each measurement of the measured spectra the average of 2 or more resolution elements in the spectra of the powers of the measured interferogram to compute bᵢ.

16. A Fourier transform spectrometer as in claim 12 wherein:
the amplifier uses an AC signal channel.

17. A Fourier transform spectrometer as in claim 16 wherein:
a DC offset is taken from the measured interferogram collected by a DC coupled amplifier.

19. A Fourier transform spectrometer as in claim 12 wherein:
the detector is a single point detector.

19. A Fourier transform spectrometer as in claim 12 wherein:
the detector is a one dimensional detector.

20. A Fourier transform spectrometer as in claim 12 wherein:
the detector is a two dimensional detector.

21. A Fourier transform spectrometer as in claim 12 wherein:
the detector is a photovoltaic detector.

22. A Fourier transform spectrometer as in claim 12 wherein:
the detector is a photoconducting detector.

23. A Fourier transform spectrometer as in claim 12 wherein:
the detector is a bolometric detector.
